(19) United States
(12) Patent Application Publication
(10) Pub. No.: US 2026/0270118 A1
(43) Pub. Date: Sep. 10, 2026

(54) BW320 RANGING SECURE EHT-LTF SEQUENCE GENERATION

(71) Applicant: MEDIATEK INC., Hsinchu City (TW)

(72) Inventors: Shuling FENG, San Jose, CA (US); Jianhan LIU, San Jose, CA (US); Thomas Edward PARE, Jr., San Jose, CA (US)

(21) Appl. No.: 18/873,546

(22) PCT Filed: Oct. 26, 2023
(86) PCT No.: PCT/CN2023/126904

§ 371 Date: Dec. 10, 2024

Related U.S. Application Data
(60) Provisional application No. 63/381,142, filed on Oct. 27, 2022.
(60) Provisional application No. 63/381,317, filed on Oct. 28, 2022.

(51) Int. Cl. H04L 25/02

(52) U.S. Cl. CPC H04L 25/0226

(57) ABSTRACT

Various techniques pertaining to bandwidth 320 MHz (BW320) ranging secure extreme-high throughput (EHT) long training field (EHT-LTF) sequence generation for wireless ranging and sensing are described. A processor of an apparatus (e.g., a station (STA)) constructs a randomized extreme-high throughput (EHT) long training field (EHT-LTF) sequence of an EHT format secure ranging null data packet (NDP). The processor performs ranging in a 320 MHz bandwidth using the EHT format secure ranging NDP. The EHT format secure ranging NDP may be either of two types comprising an EHT secure ranging NDP and an EHT trigger-based (TB) secure ranging NDP.

### CROSS REFERENCE TO RELATED PATENT APPLICATION

The present disclosure is part of a non-provisional patent application claiming the priority benefit of U.S. Provisional Patent Application Nos. 63/381,142 and 63/381,317, filed 27 Oct. 2022 and 28 Oct. 2022, respectively, the contents of which herein being incorporated by reference in their entirety.

### TECHNICAL FIELD

The present disclosure is generally related to wireless communications and, more particularly, to bandwidth 320 MHz (BW320) ranging secure extreme-high throughput (EHT) long training field (EHT-LTF) sequence generation for wireless ranging and wireless sensing.

### BACKGROUND

Unless otherwise indicated herein, approaches described in this section are not prior art to the claims listed below and are not admitted as prior art by inclusion in this section.

In wireless communications, such as WiFi (or Wi-Fi) and wireless local area networks (WLANs) in accordance with Institute of Electrical and Electronics Engineers (IEEE) 802.11 specifications, high-efficiency (HE) based ranging according to the IEEE 802.11az specification supports up to a bandwidth of 160 MHz (BW160), EHT-capable devices according to the IEEE 802.11be specification support up to BW320, and EHT based ranging according to the IEEE 802.11bk specification supports BW320. Thus, the HE based ranging specifications under IEEE 802.11az needs to be expanded to EHT based ranging in IEEE 802.11bk in order to support BW320 ranging. However, at present time, BW320 EHT ranging null data packet (NDP) and EHT trigger-based (TB) ranging NDP in the physical layer (PHY) remain to be defined. Moreover, secure long training field (LTF) features for EHT-LTFs also need to be defined. Therefore, there is a need for a solution of BW320 ranging secure EHT-LTF sequence generation for wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to BW320 ranging secure EHT-LTF sequence generation for wireless ranging. Thus, it is believed that various schemes proposed herein may address or otherwise alleviate the aforementioned issue(s), such as reduction in performance overhead. Since IEEE 802.11bf's support of BW320 sensing is based on 802.11bk, this BW320 ranging secure EHT-LTF solution under the proposed schemes also can be applied to BW320 sensing secure EHT-LTF generation.

In one aspect, a method may involve constructing a randomized EHT-LTF sequence of an EHT format secure ranging NDP. The method may also involve performing ranging in a 320 MHz bandwidth using the EHT format secure ranging NDP, which may be either of two types: an EHT secure ranging NDP or an EHT TB secure ranging NDP.

In another aspect, an apparatus may include a processor having circuity configured to perform certain operations. For instance, the processor may be configured to construct a randomized EHT-LTF sequence of an EHT format secure ranging NDP. The processor may also be configured to perform ranging in a 320 MHz bandwidth using the EHT format secure ranging NDP, which may be either of two types: an EHT secure ranging NDP or an EHT TB secure ranging NDP.

It is noteworthy that, although description provided herein may be in the context of certain radio access technologies, networks and network topologies such as, WiFi/WLAN, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a schematic diagram of an example design based on which various proposed schemes in accordance with the present disclosure may be implemented.

FIG. 2 is a schematic diagram of an example design based on which various proposed schemes in accordance with the present disclosure may be implemented.

FIG. 3 is a flowchart of an example process in accordance with an implementation of the present disclosure.

FIG. 4 is a diagram of an example definition of puncturing patterns.

FIG. 5 is a diagram of an example definition of puncturing patterns.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to BW320 ranging secure EHT-LTF sequence generation for wireless ranging. According to the present disclosure, a number of possible solutions may be implemented separately or jointly. That is, although these possible solutions may be described below separately, two or more of these possible solutions may be implemented in one combination or another.

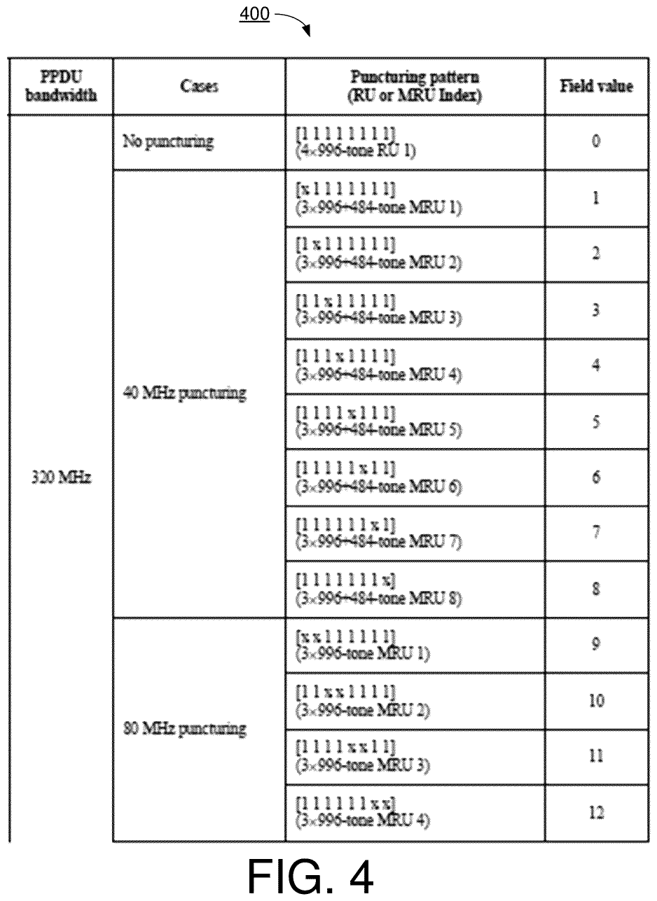

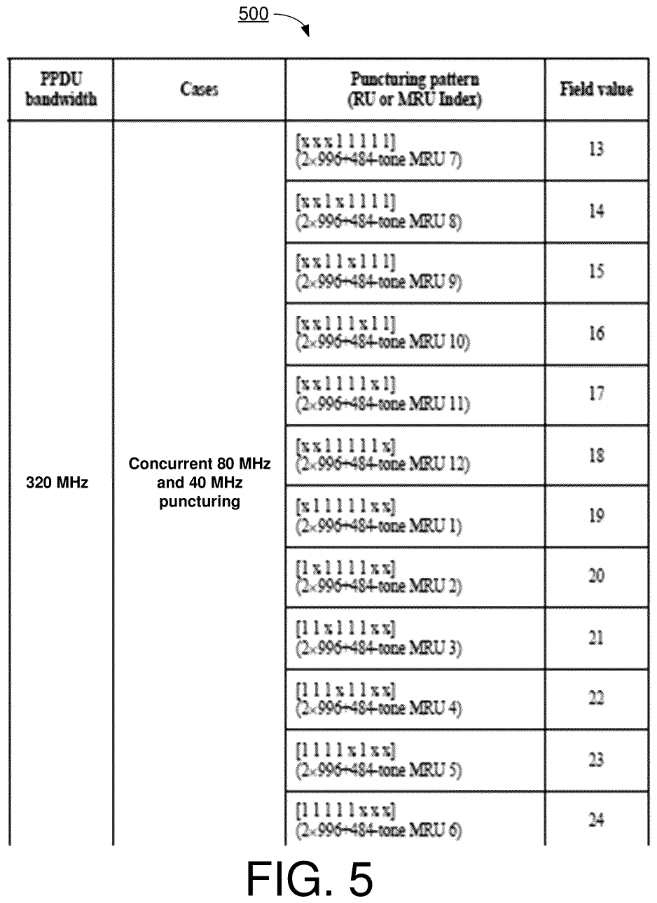

Under a proposed scheme in accordance with the present disclosure, with respect to support of puncturing patterns by BW320 ranging, preamble puncturing patterns may be not limited in IEEE 802.11bk BW320 NDPs, with or without secure features. Under the proposed scheme, BW320 NDPs (i.e., EHT ranging NDPs and EHT TB ranging NDPs) may support all static preamble puncturing patterns indicated in a Punctured Channel Info subfield of a universal signal (U-SIG) field (as specified in IEEE 802.11be) for BW320 cases. It may be up to a receiver to decide whether or not to use an advanced algorithm to enhance time of arrival (TOA) estimation on a non-continuous bandwidth or a continuous part of the bandwidth. Puncturing patterns of the continuous bandwidth may be tested in WiFi Alliance as basic cases. Under the proposed scheme, a randomized EHT-LTF may be constructed in a BW320 EHT format secure ranging NDP to support all preamble puncturing patterns specified by the Punctured Channel Info subfield of U-IG field. An example of definition of puncturing patterns, according to Table 36-28 and Table 36-30 in IEEE 802.11be draft text D 3.0, is shown in design 400 of FIG. 4 and design 500 of FIG. 5 for 40 MHz puncturing, 80 MHz puncturing, as well as concurrent 40 MHz and 80 MHz puncturing, respectively, for a BW320 EHT format secure ranging NDP in a physical-layer protocol data unit (PPDU).

Under a proposed scheme in accordance with the present disclosure, with respect to randomized LTF sequence for secure NDP, generation of a randomized HE-LTF in IEEE 802.11az may be expanded to EHT-LTF supporting ranging with BW320. In general, a segment parser (which may parse in a round-robin fashion) may be used to divide pseudorandom octets (8 bits) between a sequence for a lower 80 MHz segment and another sequence for an upper 80 MHz segment in a 160 MHz secure LTF sequence.

Under the proposed scheme, generation of a randomized EHT-LTF sequence in BW320 secure ranging NDP may involve certain operations. For instance, a pseudorandom sequence may be generated for a BW320 EHT-LTF. Then, a segment parser (which may parse in a round-robin fashion) may divide a plurality of pseudorandom octets from an input pseudorandom sequence, as octet sequences, among multiple 80 MHz segments (e.g., from the lowest frequency to the highest frequency). Afterwards, the octet sequences may be modulated to 64 quadrature amplitude modulation (64QAM) symbols which are mapped to 80 MHz segments or sub-channels of the BW320. Under the proposed scheme, there may be two options with respect to tone mapping and puncturing.

In a first option (Option 1) of tone mapping and puncturing, the 64QAM symbols may be mapped to non-zero tones in each 80 MHz frequency segment or sub-channel in a same way as defined in IEEE 802.11az. Punctured tones in each 80 MHz sub-channel may be replaced with 0s according to the puncturing pattern(s) indicated by the Punctured Channel Info subfield of the U-SIG field. Under the proposed scheme, the replacement of punctured tones with 0s may involve nulling the punctured tones or dropping the punctured tones. Under the proposed scheme, mapping and replacing actions may happen at the same time. That is, each of the punctured tones may be replaced with value “0” during mapping. Alternatively, tone mapping may take place first before punctured tones are replaced with the value “0.”

In a second option (Option 2) of tone mapping and puncturing, the 64QAM symbols may be mapped to occupied tones sequentially, with punctured tones skipped in each 80 MHz frequency segment or sub-channel according to the puncturing pattern(s) indicated by the Punctured Channel Info subfield of the U-SIG field. Leftover symbols, if any, may be discarded.

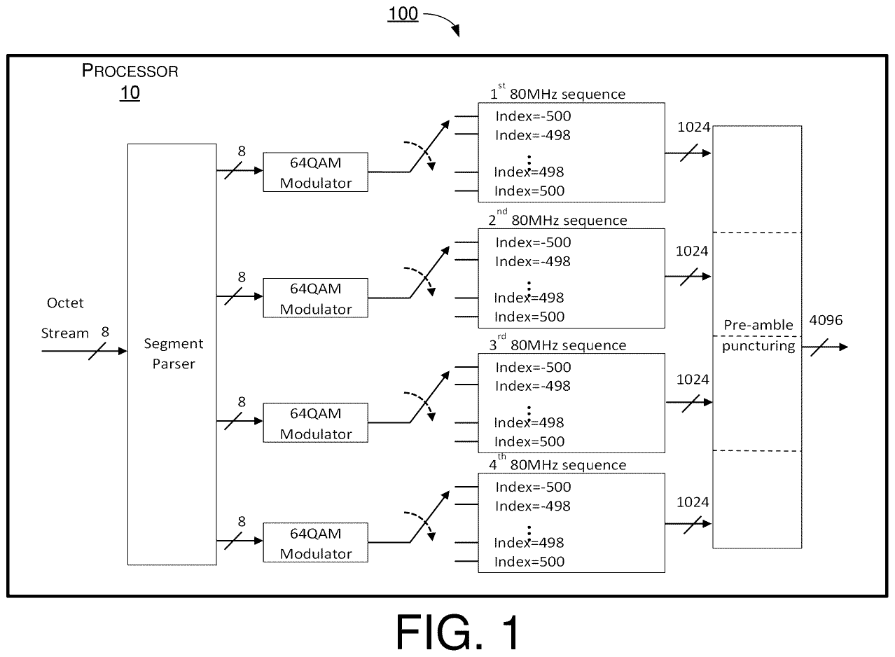

FIG. 1 illustrates an example design 100 under a proposed scheme in accordance with the present disclosure may be implemented. Design 100 may pertain to the design of a processor 10 with circuitry configured to construct or otherwise generate a secure randomized EHT-LTF in a BW320 secure ranging NDP under Option 1. Referring to FIG. 1, in design 100, a segment parser (which may parse in a round-robin fashion) may divide a plurality of pseudorandom octets (of an input pseudorandom stream of bits) among a first 80 MHz sequence corresponding to a first 80 MHz frequency segment, a second 80 MHz sequence corresponding to a second 80 MHz frequency segment, a third 80 MHz sequence corresponding to a third 80 MHz frequency segment, and a fourth 80 MHz sequence corresponding to a fourth 80 MHz frequency segment (e.g., in an ascending order from a lowest frequency to a highest frequency). That is, the segment parser may parse the pseudorandom octets to each of the first, second, third and fourth 80 MHz sequences through a respective 64QAM modulator. Outputs of the first, second, third and fourth 80 MHz sequences may be placed in a 320 MHz EHT format secure ranging NDP in a PPDU with pattern(s) of preamble puncturing for BW320 ranging. Under the proposed scheme, mapping of the pseudorandom octets to each of the four 80 MHz sequences may be according to the puncturing pattern(s). That is, in some implementations, mapping and preamble puncturing may occur at the same time. Alternatively, in other implementations, mapping may take place first followed by preamble puncturing later.

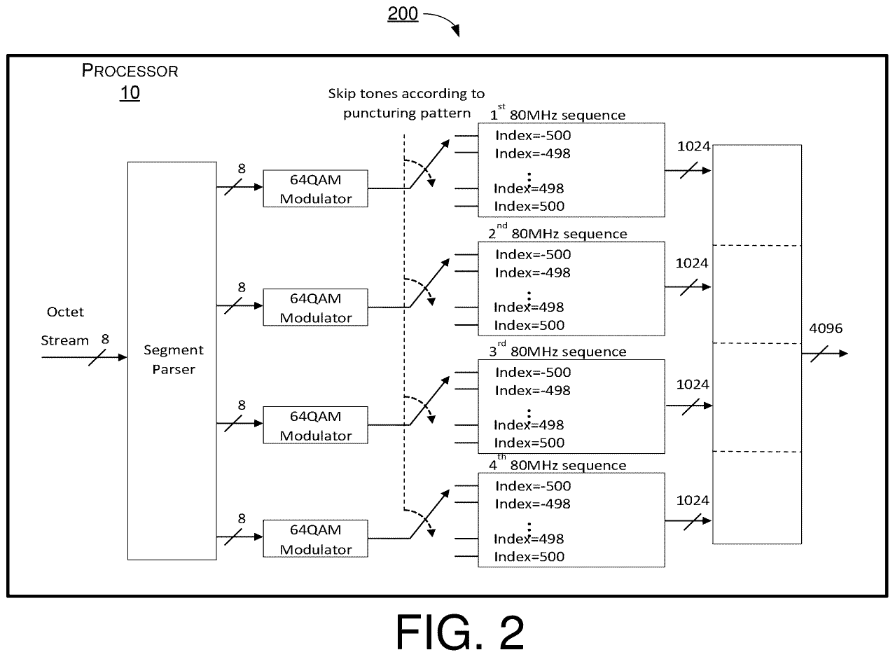

FIG. 2 illustrates an example design 200 under a proposed scheme in accordance with the present disclosure may be implemented. Design 200 may pertain to the design of a processor 10 with circuitry configured to construct or otherwise generate a randomized EHT-LTF in a BW320 secure ranging NDP under Option 2. Referring to FIG. 2, in design 200, a segment parser (which may parse in a round-robin fashion) may divide a plurality of pseudorandom octets (of an input pseudorandom stream of bits) among a first 80 MHz sequence corresponding to a first 80 MHz frequency segment, a second 80 MHz sequence corresponding to a second 80 MHz frequency segment, a third 80 MHz sequence corresponding to a third 80 MHz frequency segment, and a fourth 80 MHz sequence corresponding to a fourth 80 MHz frequency segment (e.g., in an ascending order from a lowest frequency to a highest frequency). That is, the segment parser may parse the pseudorandom octets to each of the first, second, third and fourth 80 MHz sequences through a respective 64QAM modulator. Outputs of the first, second, third and fourth 80 MHz sequences may be placed in a 320 MHz EHT format secure ranging NDP in a PPDU for BW320 ranging. Different from design 100, in design 200, punctured tones may be skipped, according to the puncturing pattern(s), before mapping.

### Illustrative Processes

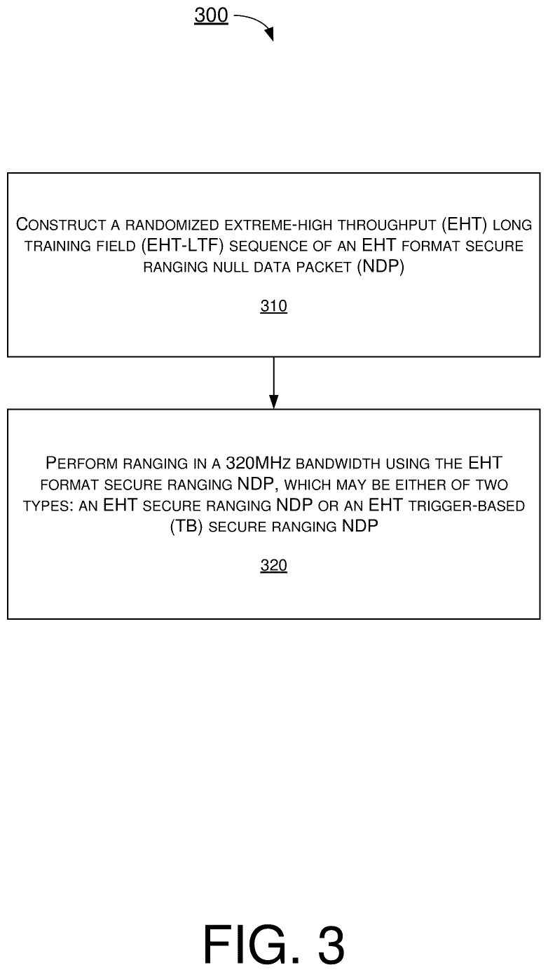

FIG. 3 illustrates an example process 300 in accordance with an implementation of the present disclosure. Process 300 may represent an aspect of implementing various proposed designs, concepts, schemes, systems and methods described above. More specifically, process 300 may represent an aspect of the proposed concepts and schemes pertaining to BW320 ranging secure EHT-LTF sequence generation for wireless ranging in accordance with the present disclosure. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively, in a different order. Furthermore, one or more of the blocks/sub-blocks of process 300 may be executed repeatedly or iteratively. Process 300 may be implemented by or in sensing receiver 10 in which design 100 is implemented. Solely for illustrative purposes and without limiting the scope, process 300 is described below in the context of design 100 and design 200 implemented in a processor (e.g., processor 10) of a station (STA) (e.g., an access point (AP) STA or non-AP STA) in a WLAN. Process 300 may begin at block 310.

At 310, process 300 may involve processor 10 constructing a randomized EHT-LTF sequence of an EHT format secure ranging NDP. Process 300 may proceed from 310 to 320.

At 320, process 300 may involve processor 10 performing ranging in a 320 MHz bandwidth using the EHT format secure ranging NDP. The EHT format secure ranging NDP may be either of two types comprising an EHT secure ranging NDP and an EHT TB secure ranging NDP.

In some implementations, in constructing the randomized EHT-LTF sequence, process 300 may involve processor 10 performing preamble puncturing using a puncture pattern indicated in a Punctured Channel Info subfield of a universal signal (U-SIG) field for the 320 MHz bandwidth. In some implementations, the puncture pattern indicated in the Punctured Channel Info subfield of the U-SIG field may be one of the multiple puncture patterns specified by an IEEE 802.11be specification.

In some implementations, in constructing the randomized EHT-LTF sequence, process 300 may involve processor 10 expanding generation of a randomized HE-LTF field using a HE-LTF according to an IEEE 802.11az specification to the randomized EHT-LTF which is used in ranging in the 320 MHz bandwidth.

In some implementations, in constructing the randomized EHT-LTF sequence, process 300 may involve processor 10 certain operations. For instance, process 300 may involve processor 10 generating a pseudorandom sequence for the 320 MHz bandwidth. Additionally, process 300 may involve processor 10 parsing the pseudorandom sequence as a plurality of pseudorandom octets among a first 80 MHz sequence corresponding to a first 80 MHz frequency segment, a second 80 MHz sequence corresponding to a second 80 MHz frequency segment, a third 80 MHz sequence corresponding to a third 80 MHz frequency segment, and a fourth 80 MHz sequence corresponding to a fourth 80 MHz frequency segment of the 320 MHz bandwidth. Moreover, process 300 may involve processor 10 modulating the plurality of pseudorandom octets to 64QAM symbols. Furthermore, process 300 may involve processor 10 tone mapping and puncturing the 64QAM symbols of the first 80 MHz sequence, the second 80 MHz sequence, the third 80 MHz sequence and the fourth 80 MHz sequence.

In some implementations, in tone mapping, process 300 may involve processor 10 replacing each of one or more punctured tones in each of the first 80 MHz sequence, the second 80 MHz sequence, the third 80 MHz sequence and the fourth 80 MHz sequence with a value of 0 according to a puncturing pattern. In some implementations, the puncturing pattern may be indicated in a Punctured Channel Info subfield of a U-SIG field. In some implementations, in replacing each of the one or more punctured tones with the value of 0, process 300 may involve processor 10 nulling or dropping each of the one or more punctured tones.

In some implementations, in tone mapping and puncturing, process 300 may involve processor 10 performing certain operations. For instance, process 300 may involve processor 10 mapping the 64QAM symbols of the first 80 MHz sequence, the second 80 MHz sequence, the third 80 MHz sequence and the fourth 80 MHz sequence. Additionally, after the mapping, process 300 may involve processor 10 replacing each of one or more punctured tones with a value of 0. Alternatively, in tone mapping and puncturing, process 300 may involve processor 10 replacing each of one or more punctured tones with a value of 0 during mapping of the 64QAM symbols of the first 80 MHz sequence, the second 80 MHz sequence, the third 80 MHz sequence and the fourth 80 MHz sequence.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
constructing a randomized extreme-high throughput (EHT) long training field (EHT-LTF) sequence of an EHT format secure ranging null data packet (NDP); and
performing ranging in a 320 MHz bandwidth using the EHT format secure ranging NDP,
wherein the EHT format secure ranging NDP is either of two types comprising an EHT secure ranging NDP and an EHT trigger-based (TB) secure ranging NDP.

2. The method of claim 1, wherein the constructing of the randomized EHT-LTF sequence comprises performing preamble puncturing using a puncture pattern indicated in a Punctured Channel Info subfield of a universal signal (U-SIG) field for the 320 MHz bandwidth.

3. The method of claim 2, wherein the puncture pattern indicated in the Punctured Channel Info subfield of the U-SIG field is one of multiple puncture patterns specified by an Institute of Electrical and Electronics Engineers (IEEE) 802.11be specification.

4. The method of claim 1, wherein the constructing of the randomized EHT-LTF sequence comprises expanding generation of a randomized high-efficiency (HE) long training field (HE-LTF) field using a HE-LTF according to an Institute of Electrical and Electronics Engineers (IEEE) 802.11az specification to the randomized EHT-LTF which is used in ranging in the 320 MHz bandwidth.

5. The method of claim 1, wherein the constructing of the randomized EHT-LTF sequence comprises:
generating a pseudorandom sequence;
parsing the pseudorandom sequence as a plurality of pseudorandom octets among a first 80 MHz sequence corresponding to a first 80 MHz frequency segment, a second 80 MHz sequence corresponding to a second 80 MHz frequency segment, a third 80 MHz sequence corresponding to a third 80 MHz frequency segment, and a fourth 80 MHz sequence corresponding to a fourth 80 MHz frequency segment of the 320 MHz bandwidth;
modulating the plurality of pseudorandom octets to 64 quadrature amplitude modulation (64QAM) symbols; and
tone mapping and puncturing the 64QAM symbols of the first 80 MHz sequence, the second 80 MHz sequence, the third 80 MHz sequence and the fourth 80 MHz sequence.

6. The method of claim 5, wherein the tone mapping comprises replacing each of one or more punctured tones in each of the first 80 MHz sequence, the second 80 MHz sequence, the third 80 MHz sequence and the fourth 80 MHz sequence with a value of 0 according to a puncturing pattern.

7. The method of claim 6, wherein the puncturing pattern is indicated in a Punctured Channel Info subfield of a universal signal (U-SIG) field.

8. The method of claim 6, wherein the replacing of each of the one or more punctured tones with the value of 0 comprises nulling or dropping each of the one or more punctured tones.

9. The method of claim 5, wherein the tone mapping and puncturing comprises:
mapping the 64QAM symbols of the first 80 MHz sequence, the second 80 MHz sequence, the third 80 MHz sequence and the fourth 80 MHz sequence; and
after the mapping, replacing each of one or more punctured tones with a value of 0.

10. The method of claim 5, wherein the tone mapping and puncturing comprises replacing each of one or more punctured tones with a value of 0 during mapping of the 64QAM symbols of the first 80 MHz sequence, the second 80 MHz sequence, the third 80 MHz sequence and the fourth 80 MHz sequence.

11. An apparatus, comprising:
a processor comprising circuity configured to perform operations comprising:
constructing a randomized extreme-high throughput (EHT) long training field (EHT-LTF) sequence of an EHT format secure ranging null data packet (NDP); and
performing ranging in a 320 MHz bandwidth using the EHT format secure ranging NDP,
wherein the EHT format secure ranging NDP is either of two types comprising an EHT secure ranging NDP and an EHT trigger-based (TB) secure ranging NDP.

12. The apparatus of claim 11, wherein the constructing of the randomized EHT-LTF sequence comprises performing preamble puncturing using a puncture pattern indicated in a Punctured Channel Info subfield of a universal signal (U-SIG) field for the 320 MHz bandwidth.

13. The apparatus of claim 12, wherein the puncture pattern indicated in the Punctured Channel Info subfield of the U-SIG field is one of multiple puncture patterns specified by an Institute of Electrical and Electronics Engineers (IEEE) 802.11be specification.

14. The apparatus of claim 11, wherein the constructing of the randomized EHT-LTF sequence comprises expanding generation of a randomized high-efficiency (HE) long training field (HE-LTF) field using a HE-LTF according to an Institute of Electrical and Electronics Engineers (IEEE) 802.11az specification to the randomized EHT-LTF which is used in ranging in the 320 MHz bandwidth.

15. The apparatus of claim 11, wherein the constructing of the randomized EHT-LTF sequence comprises:
generating a pseudorandom sequence;
parsing, with a segment parser, the pseudorandom sequence as a plurality of pseudorandom octets among a first 80 MHz sequence corresponding to a first 80 MHz frequency segment, a second 80 MHz sequence corresponding to a second 80 MHz frequency segment, a third 80 MHz sequence corresponding to a third 80 MHz frequency segment, and a fourth 80 MHz sequence corresponding to a fourth 80 MHz frequency segment of the 320 MHz bandwidth;
modulating, with a 64 quadrature amplitude modulation (64QAM) modulator, the plurality of pseudorandom octets to 64QAM symbols; and
tone mapping and puncturing the 64QAM symbols of the first 80 MHz sequence, the second 80 MHz sequence, the third 80 MHz sequence and the fourth 80 MHz sequence.

16. The apparatus of claim 15, wherein the tone mapping comprises replacing each of one or more punctured tones in each of the first 80 MHz sequence, the second 80 MHz sequence, the third 80 MHz sequence and the fourth 80 MHz sequence with a value of 0 according to a puncturing pattern.

17. The apparatus of claim 16, wherein the puncturing pattern is indicated in a Punctured Channel Info subfield of a universal signal (U-SIG) field.

18. The apparatus of claim 16, wherein the replacing of each of the one or more punctured tones with the value of 0 comprises nulling or dropping each of the one or more punctured tones.

19. The apparatus of claim 15, wherein the tone mapping and puncturing comprises:
mapping the 64QAM symbols of the first 80 MHz sequence, the second 80 MHz sequence, the third 80 MHz sequence and the fourth 80 MHz sequence; and
after the mapping, replacing each of one or more punctured tones with a value of 0.

20. The apparatus of claim 15, wherein the tone mapping and puncturing comprises replacing each of one or more punctured tones with a value of 0 during mapping of the 64QAM symbols of the first 80 MHz sequence, the second 80 MHz sequence, the third 80 MHz sequence and the fourth 80 MHz sequence.
